(19) United States
(12) Patent Application Publication
(10) Pub. No.: US 2009/0116081 A1
(43) Pub. Date: May 7, 2009

(54) Image Scanning Device and Image Scanning Method

(75) Inventor: Eiji KASAI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/264,788

(22) Filed: Nov. 4, 2008

(30) Foreign Application Priority Data
Nov. 7, 2007 (JP) 2007-289219

(51) Int. Cl. G06K 9/48; H04N 1/04

(52) U.S. Cl. 358/498; 382/199

(57) ABSTRACT

The scanning operation controller allocates a scanned image memory area of a predetermined document size within a memory, and stores the image data of the scanned document to the scanned image memory area. The image processor eliminates unneeded data from the data in the scanned image memory area of the predetermined document size to thereby produce output image data, based on a document size of the scanned document that is detected after the automatic document feeder has initiated the feed of the document to the image reader.

### CROSS-REFERENCE TO RELATED APPLICATIONS

The present application claims the priority based on Japanese Patent Application No. 2007-289219 filed on Nov. 7, 2007, the disclosure of which is hereby incorporated by reference in its entirety.

### BACKGROUND OF THE INVENTION

1. Field of the Invention

The present invention relates to an image scanning device of pass-through type.

2. Description of the Related Art

A pass-through scanner has a fixed image sensor and an automatic document feeder (ADF) that feeds to the image sensor a document which has been placed on the document loading stage of the ADF. The image sensor sequentially scans the document as it is fed in.

If documents that have been placed on the document loading stage are all of the same size, on the basis of document size which has been detected previously by document size detecting means provided to the document loading stage, the image sensor will be set so as to scan only an image of the required area of the documents fed to it, thereby making it possible to reduce the time needed for the scanning operation, as well as the amount of memory needed to store the scanned data.

However, if documents of different sizes are placed on the document loading stage, the document size detecting means provided to the document loading stage will only be able to detect the largest size of the document in the lengthwise direction (direction parallel to the feed direction) and the largest size of the document in the width direction (direction perpendicular to the feed direction) from among the multiple documents of varying size. As a result, it is not possible to detect the actual size of the document prior to scanning the document, nor could necessary sections of a document be distinguished from unneeded sections, and thus the operation of the image sensor cannot be set so as to scan only an image of the required area of the documents fed to it.

JP2003-101769A discloses a pass-through scanner that, in the event that a mixed document mode has been selected, initiates image scanning by the image scanning section when the leading edge of the document fed by the automatic document feeder has reached the image scanning section, despite the document size detecting means having not yet detected the document size; and creates preliminary page data on the assumption that the original document is of prescribed size equivalent to the largest document size that the pass-through scanner is capable of copying. Once the document size detecting means has detected the trailing edge of the document and verified the length of the document in the feed direction, the scanner will then compress the data from the preliminary page data size to a prescribed size, to create the page data.

However, a problem with the device taught in JP2003-101769A is that since preliminary page data is created on the assumption of an original of prescribed size equivalent to the largest document size that the pass-through scanner is capable of copying, no reduction in the memory capacity needed to store the scanned data will be possible. Another problem is that since prior to scanning the document actual document width cannot be detected and necessary portions of the document cannot be distinguished from unneeded portions, operation of the image sensor cannot be set so as to scan only an image of a desired area of the document fed to it.

### SUMMARY OF THE INVENTION

An object of the present invention is to provide technology for implementation in a pass-through image scanning device, whereby in the event that a mixed load of documents of differing size is loaded into the automatic document feeder, scanning of the documents can be carried out appropriately for each document size without risk of increased processing time. Another object is to reduce the amount of memory needed to store the scanned data. Still another object is to produce output image data from which unneeded image data has been eliminated.

According to an aspect of the present invention, there is provided an image scanning device. The image scanning device includes an automatic document feeder, an image reader, a memory, a scanning operation controller, and an image processor. The scanning operation controller allocates a scanned image memory area of a predetermined document size within the memory, and stores the image data of the scanned document to the scanned image memory area. The image processor eliminates unneeded data from the data in the scanned image memory area of the predetermined document size to thereby produce output image data, based on a document size of the scanned document that is detected after the automatic document feeder has initiated the feed of the document to the image reader.

According to the image scanning device, the scanned image memory area will be allocated on the assumption that the size of the document is equal to a prescribed document, and the image data of the scanned document is stored to the scanned image memory area, whereby it will be possible to reduce the memory capacity needed to store the scanned data. Furthermore, output image data can be created by eliminating unneeded data from the data stored in the scanned image memory area, on the basis of the scanned document size detected subsequent to the feed of the document. Accordingly when a mixed load of documents of differing size is loaded into to the automatic document feeder, scanning of the documents can be carried out appropriately for each document size without risk of increased processing time; the amount of memory needed to store the scanned data can be reduced; and output image data from which unneeded data has been eliminated can be created.

The present invention is not limited to embodiment in a device mode such as the image scanning devices set forth above, and may also be embodied as a method invention, such as an image scanning method.

### BRIEF DESCRIPTION OF THE DRAWINGS

FIG. 1 is a block diagram depicting the principal parts of a copier device in which an image scanning device according to an embodiment of the present invention is implemented;

FIG. 2 illustrates a simplified configuration of the automatic document feeder;

FIG. 3 is a flowchart depicting the flow of a document scanning operation carried out by the image scan controller, where copying of a document is carried out by the copier device; and

FIG. 4 illustrates scanned image data stored in the scanned image memory.

### DESCRIPTION OF THE PREFERRED EMBODIMENT

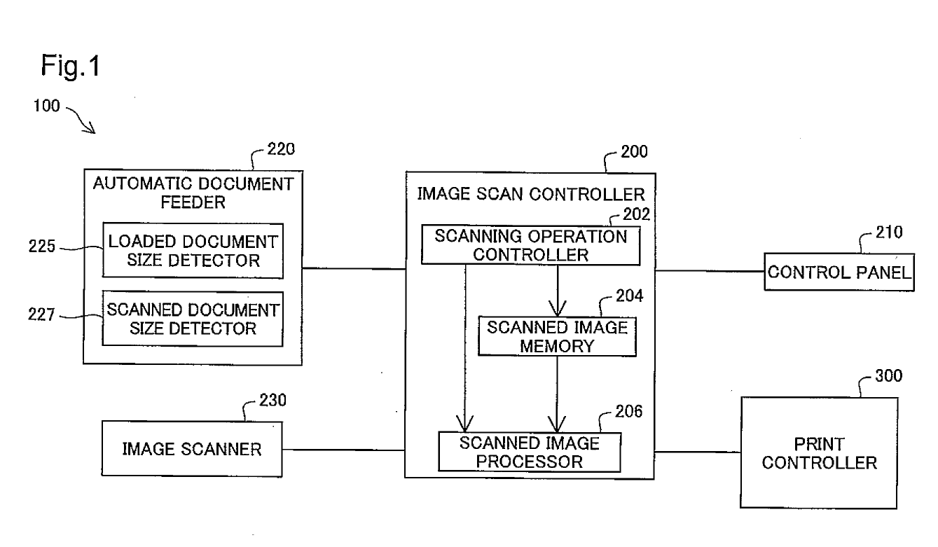

FIG. 1 is a block diagram depicting the principal parts of a copier device in which an image scanning device according to an embodiment of the present invention is implemented. This copier device 100 includes an image scan controller 200 that controls operation of the image scanning device that scans documents; and a print controller 300 that controls operation of a printing unit that outputs images represented by image data of scanned documents. A control panel 210, an automatic document feeder (ADF) 220, and an image scanner 230 are connected to the image scan controller 200. The image scanner 230 may be also referred to as “image reader 230.”

The image scan controller 200 and the print controller 300 are each equipped with a CPU, memory, and so on (not shown). Their respective functions are carried out through execution by the CPU of various programs stored in memory.

The image scan controller 200 has a scanning operation controller 202, a scanned image memory 204, and a scanned image processor 206. The scanning operation controller 202 controls the automatic document feeder 220 and the image scanner 230, and executes document scanning operations and document size detection operations. The scanned image memory 204 stores scanned document image data. On the basis of an output size determined from the document size and the set magnification, the scanned image processor 206 will create output image data from the document image data that has been stored in the scanned image memory 204.

The control panel 210 has control buttons for inputting various parameters such as magnification, output paper size, and mixed document loading mode, as well as a display for displaying input parameters.

The automatic document feeder 220 performs feed of documents that have been placed on the document loading stage to the image scanner 230, as well as discharge of documents from the image scanner 230 to a document ejection stage. The automatic document feeder 220 is furnished with a loaded document size detector 225 for detecting size of documents that have been placed on the document loading stage; and a scanned document size detector 227 for detecting size of documents that have been fed into the image scanner 230.

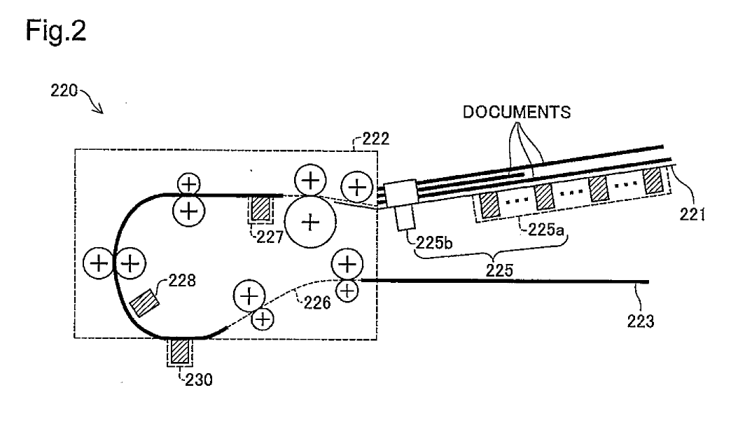

FIG. 2 is an illustration depicting a simplified configuration of the automatic document feeder 220. The automatic document feeder 220 includes a document loading stage 221, a document feed mechanism 222, and a document ejection stage 223.

The document loading stage 221 is provided with a document size detector 225 having a length detector 225a for detecting loaded document size in the direction coincident with the feed direction (length), and a width detector 225b for detecting loaded document size in the direction perpendicular to the feed direction (width); the size of documents that have been loaded onto the document loading stage 221 will be detected automatically by the loaded document size detector 225. However, where a plurality of documents of differing size has been loaded, the size of the largest document among the loaded documents will be detected. The detected document size is not necessarily limited to the length (size in the direction of the feed direction) and the width (size in the direction perpendicular to the feed direction) of a single document, and in some instances may be those of different documents. The length detector 225a and the width detector 225b may be easily constructed using a variety of conventional sensors such as photo-interrupters or other such photoelectric conversion elements, mechanical switches, scalers or the like.

The image scanner 230, which is equipped with a scanning optical system having a fixed image sensor, is disposed below the document feed mechanism 222; within the document feed mechanism 222 there is defined a document feed path 226 for feeding a document that has been placed on the document loading stage from the document loading stage 221, over the image scanner 230, and then to the document ejection stage 223.

In proximity to the document loading stage 221 of the document feed path 226 there is provided a scanned document size detector 227 for detecting the length of the document by detecting the leading edge and the trailing edge of the document being transported from the document loading stage 221, as well as for detecting the width of the document. This scanned document size detector 227 may be constructed easily through the use of a linear sensor having a plurality of photo-interrupters or other such photoelectric conversion elements arranged along the direction perpendicular to the feed direction, for example.

Additionally, a scan timing sensor 228 is disposed in proximity to the image scanner 230 of the document feed path 226, to the upstream side thereof. This scan timing sensor 228 detects the leading edge and the trailing edge of the document being fed in. The timing for starting and ending the scan of the document will be determined based on the sensor results.

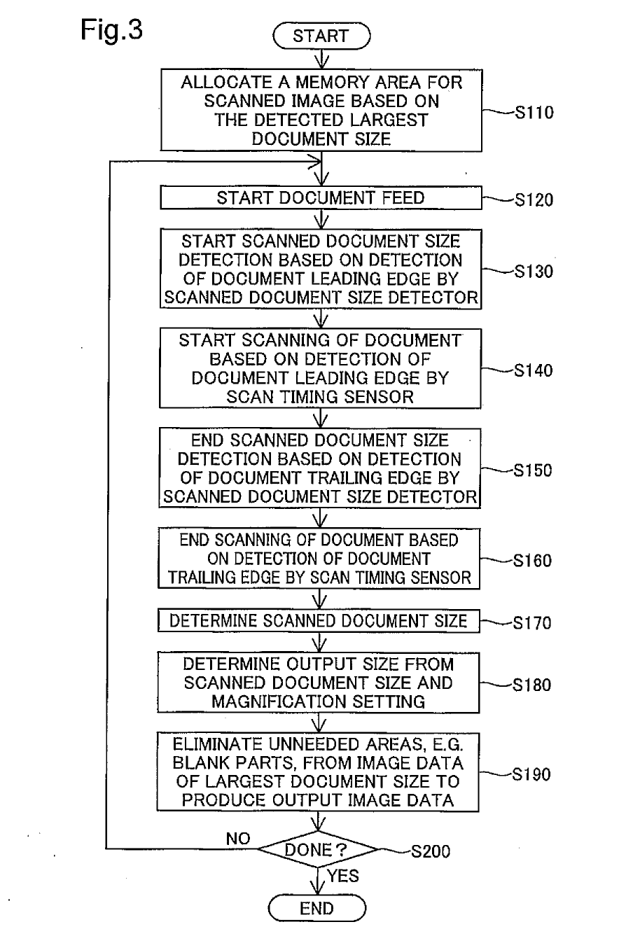

FIG. 3 is a flowchart depicting the flow of a document scanning operation carried out by the image scan controller 200, where copying of a document is carried out by the copier device 100.

When the document copying operation starts, first, the scanning operation controller 202 detects the largest document size among documents loaded into the document loading stage 221, using the loaded document size detector 225 of the automatic document feeder 220. Here the “largest document size” means the largest size in the feed direction as well as the largest size in the direction perpendicular to the feed direction within a mixed load of documents. Based on this acquired largest document size, the width of scan by the image scanner 230 is determined, and a memory area for storing the scanned image data is allocated in the scanned image memory 204 in Step S110.

Next, the scanning operation controller 202, using the document feed mechanism 222 of the automatic document feeder 220, discharges the lead document loaded into the document loading stage 221 into the document feed path 226 of the document feed mechanism 222, then initiates feed to the image scanner 230 and ejection to the document ejection stage 223 in Step S120.

Then, the scanning operation controller 202, using the scanned document size detector 227, determines the actual width of the document being scanned based on detection of the leading edge of the document whose feeding has commenced, as well as initiating detection of the actual length of the document being scanned in Step S130.

Then, upon detection of the leading edge of the document by the scan timing sensor 228, the scanning operation controller 202, on the assumption that the document size is the detected largest document size, initiates scanning of the document by the image scanner 230 in Step S140. The scanned image data is stored in sequence to the memory area of the detected largest document size which has been allocated in the scanned image memory 204.

Then, upon detection of the trailing edge of the document by the scanned document size detector 227, the scanning operation controller 202 terminates detection of the actual length of the scanned document in Step S150.

Then, upon detection of the trailing edge of the document by the scan timing sensor 228, the scanning operation controller 202 also terminates scanning of the document by the image scanner 230 in Step S160.

Next, on the basis of detection results of the leading edge and the trailing edge of the document by the scanned document size detector 227, the scanning operation controller 202 determines the scanned document size in Step S160.

An output size for the scanned document is then determined from the determined scanned document size, and the magnification setting that has been input from the control panel 210 in Step S180.

Next, based on this determined output size, the scanned image processor 206 generates output image data from which unneeded areas, e.g. nonprintable areas and other blank sections, have been eliminated from the data stored in the memory area of the largest document size within the scanned image memory 204; and outputs the output image thus created to the print controller 300 in Step S190. As a result, the image represented by the output image data is printed and output by the print controller 300.

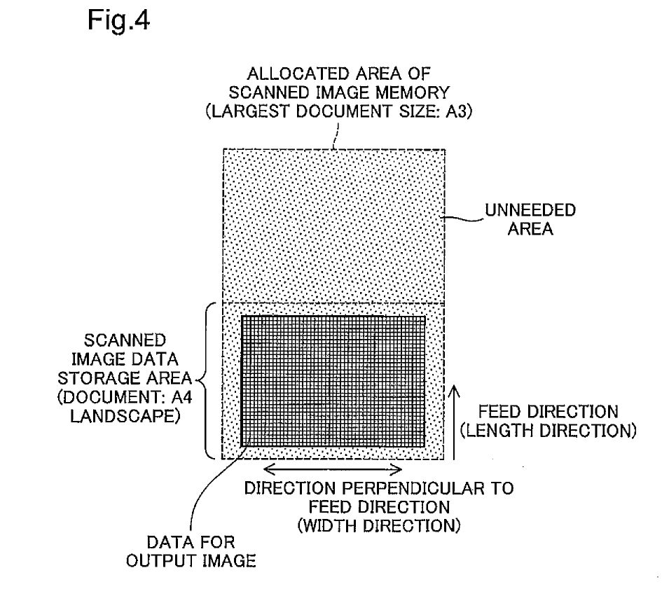

FIG. 4 illustrates scanned image data stored in the scanned image memory. Where the largest document size is “A3” for example, a memory area of the “A3” document size is allocated in the scanned image memory 204, as depicted in FIG. 4. Then, in the event that the determined scanned document size is “A4” having the same width but one-half the length (hereinafter termed document size: “A4 landscape”), the scanned image data is stored in the front half of the memory area along the feed direction (length direction). Since the determined scanned document size is “A4 landscape,” of the memory area which has been allocated in the scanned image memory 204, only the data stored in the half of the memory area will be valid; the rear half of the area will be an unneeded area. Moreover, in the front half image data area, the area corresponding to the nonprintable area and other blank section may be also unneeded data areas. Output image data may be produced by eliminating these unneeded data areas from the data stored in the scanned image memory area.

Then, if there are any remaining documents loaded into the document loading stage 221 in Step S200, the operation from Step S120 to Step S190 will be repeated, whereas if there are no remaining documents loaded into the document loading stage 221, the series of processes will terminate.

As described above, in this embodiment, an area of the scanned image memory is allocated on the assumption that the size of the document being scanned is equivalent to the largest document size that has been loaded into the document loading stage, whereupon the document will be scanned and the scanned image data temporarily stored in the scanned image memory, while also detecting the size of the actual document once feed of the document to the image scanner has been initiated. Output image data is then created through elimination of areas that have been determined as being unneeded based on the detected size of the actual document, from the scanned image data that has been stored in the allocated scanned image memory area of the largest document size. With a pass-through image scanning device, it is accordingly possible to carry out document scanning appropriately for each document size and to generate image data for output, without risk of increased processing time. Consequently, even where a mixed load of documents of differing sizes has been loaded into the automatic document feeder, it will be possible to carry out document scanning appropriately for each document size without risk of increased processing time, to reduce the amount of memory needed to store the scanned data, and to produce output image data from which unneeded image data has been eliminated.

The present invention is not limited to the embodiments set forth above, and may be embodied with various modifications without departing from the spirit and scope of the invention.

In the embodiments hereinabove, an example involving standard paper sizes is described, but no particular limitation is imposed thereby, and documents having nonstandard size may be scanned as well. In the case of documents of nonstandard size, the loaded document size detector 225 may designate a standard size that encompasses the detected document size as the largest size of the loaded documents. Analogously, the scanned document size detector 227 may designate a standard size that encompasses the detected document size as the size of the document to be scanned.

In the embodiments hereinabove, both document length and width are detected in the scanned document size detector 227; however, where a mixed load of documents have identical width, since width can be detected in the loaded document size detector 225, it is acceptable for the scanned document size detector 227 to detect length only.

Moreover, while the embodiments hereinabove describe an example in which scanned document size is detected through detection of the leading edge and the trailing edge of the document by the scanned document size detector 227, it is acceptable, for example, to perform an image recognition process on the scanned image data, and to detect the scanned document size by detecting the boundary lines of the document.

Additionally, while the embodiments hereinabove describe an example in which the largest size within a mixed load of documents is detected by the loaded document size detector 225, it is acceptable to designate the largest allowable document size scannable by the image scanning device as the largest size.

Moreover, while the embodiments hereinabove describe an example in which the output image data is printed by the print controller 300, the output image data may instead be output through fax transmission or through other data network.

What is claimed is:

1. An image scanning device comprising:
an automatic document feeder that feeds a document;
an image reader that scans the document which is being fed by the automatic document feeder:
a memory that stores image data of the document scanned by the image reader;
a scanning operation controller that controls scanning of the document and detection of document size; and
an image processor that produces output image data from the image data of the document,
wherein the scanning operation controller allocates a scanned image memory area of a predetermined document size within the memory, and stores the image data of the scanned document to the scanned image memory area, and
the image processor eliminates unneeded data from the data in the scanned image memory area of the predetermined document size to thereby produce output image data, based on a document size of the scanned document that is detected after the automatic document feeder has initiated the feed of the document to the image reader.

2. The image scanning device according to claim 1, further comprising:
a scanned document size detector disposed within a document transport path of the automatic document feeder,
wherein the scanned document size detector determines the scanned document size by detecting a leading edge and a trailing edge of the document that is moving through the document transport path by the automatic document feeder.

3. The image scanning device according to claim 2, wherein
when the automatic document feeder has a mixed load of a plurality of documents that have identical size in a direction perpendicular to the feed direction and different size in the feed direction, the scanned document size is determined through detection of length in the feed direction by the scanned document size detector.

4. The image scanning device according to claim 2, wherein
when the detected size of the scanned document is nonstandard, a standard document size that encompasses the detected scanned document size is designated as the scanned document size.

5. The image scanning device according to claim 1, wherein
the predetermined document size is defined by the largest size in the feed direction and to the largest size in a direction perpendicular to the feed direction within a mixed load of documents loaded into the automatic document feeder.

6. The image scanning device according to claim 1, wherein
the predetermined document size is the largest allowable document size that the image scanning device is capable of scanning.

7. An image scanning method comprising the steps of:
allocating a scanned image memory area of a predetermined document size within a memory;
storing image data of a scanned document to the scanned image memory area; and
eliminating unneeded data from the data in the scanned image memory area of the predetermined document size to thereby produce output image data, based on a document size of the scanned document that is detected after the feed of the document has initiated.
